(19) United States
(12) Patent Application Publication
(10) Pub. No.: US 2016/0342289 A1
(43) Pub. Date: Nov. 24, 2016

(54) INPUTTING MEDIA

(71) Applicant: HEWLETT-PACKARD DEVELOPMENT COMPANY, L.P., Houston, TX (US)

(72) Inventor: Yang HUANG, Boise, ID (US)

(73) Assignee: Hewlett-Packard Development Company, L.P., Houston, TX (US)

(21) Appl. No.: 15/115,183

(22) PCT Filed: Jan. 29, 2014
(86) PCT No.: PCT/US2014/013526

§ 371 Date: Jul. 28, 2016

(51) Int. Cl. G06F 3/0482; G06F 17/27; G06F 17/24

(52) U.S. Cl. CPC G06F 3/0482; G06F 17/24; G06F 17/276

(57) ABSTRACT

An example of an electronic device for inputting media is described herein. The electronic device can include a media input device to receive user-initiated media input at the electronic device. The electronic device can also include a sensor to collect real-time data during reception of the user-initiated media input. The electronic device can further include a processor to process the real-time data and the media input to provide a candidate based on the real-time data and the media input to be selected by a user to complete the user-initiated media input.

### BACKGROUND

Electronic devices can include methods of inputting media, such as text. These methods can include typing on a keyboard. As the size of electronic devices decreases, the size of keyboards and other devices for inputting media in the electronic devices also decreases. Methods for improving efficiency of inputting media on small devices have been developed.

### BRIEF DESCRIPTION OF THE DRAWINGS

Certain examples are described in the following detailed description and in reference to the drawings, in which:

FIG. 1 is a block diagram of an example of an electronic device;

FIG. 2 is a block diagram of an example of another electronic device;

FIG. 3 is a process flow diagram of an example of a method of inputting text; and

FIG. 4 is a block diagram of an example of a tangible, non-transitory, computer-readable medium containing code for inputting text.

### DETAILED DESCRIPTION OF SPECIFIC EMBODIMENTS

Methods for improving efficiency of inputting media on input devices, such as keyboards of mobile devices, can include predicting a user's media input and presenting candidates for completing the media input. Media is information that is input in an electronic device. Examples of media include text, symbols, images, videos, audio, a combination thereof, of any other suitable type of information. Media can be input in any suitable manner, such as typing on a keyboard, copying from an I/O device, saving to a removable storage medium, capturing an image, or any other suitable method. A candidate is text, a number, a word, a phrase, a sentence, a paragraph, a symbol, an image, an audio clip, a video clip, or a combination thereof, that is a prediction of media, such as textual input, based on the media input previously received from the user. The input can be predicted by recording previous words that a user has input and storing the words in a dictionary. When the user types, the electronic device can check the dictionary and provide candidates for the user to select instead of inputting an entire word or sentence. The dictionary can be moved from local storage on the electronic device to a cloud server and combined with dictionaries of additional electronic devices to provide a user with additional candidates. In addition, words that are currently popular in the network can be added to the dictionary. However, it can be difficult to predict a user's input at different times and in different situations employing the dictionary.

However, by collecting real-time data and basing candidates provided to the user on the real-time data, the electronic device can make more intelligent selections of candidates. Accordingly, candidates can be presented to the user that is more suitable and more likely to be selected by the user. The real-time data can include location information (e.g., the current geographic location of the device and the network location, such as the IP address, of the electronic device), the environment around the electronic device (e.g., current environment temperature, humidity, altitude, wind speed, local events, etc.), the application in which the user is inputting text (e.g., a text editor, a chatting window, an email client, a browser address window, etc.), the user's profile (e.g., the age, gender, profession, most recent more repeated words/sentences, recently used applications, recently visited websites, information from social networking sites, etc.), and recipient information (e.g., name, age, gender, etc. of a person to receive the text), or a combination thereof. The real-time data can also include previous user selection of candidates. By presenting candidates that are more likely to be selected by the user, the speed of input in electronic devices can be improved. As the device learns the user's selections and circumstances, the prediction of candidates will continue to improve, as the electronic device does not merely rely on a user's input.

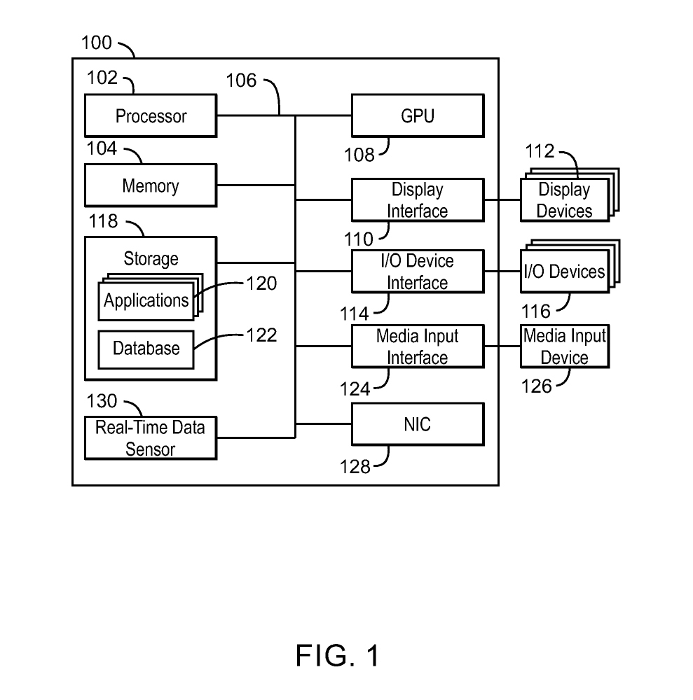

FIG. 1 is a block diagram of an example of an electronic device 100. The electronic device 100 can be a mobile device such as, for example, a laptop computer, a tablet computer, a personal digital assistant (PDA), or a cellular phone, such as a smartphone, among others. The electronic device 100 can include a processor 102 to execute stored instructions, as well as a memory device 104 that stores instructions that are executable by the processor 102. The processor 102 can be coupled to the memory device 104 by a bus 106. Additionally, the processor 102 can be a single core processor, a multi-core processor, or any number of other configurations. Furthermore, the electronic device 100 can include more than one processor 102.

The electronic device 100 can also include a graphics processing unit (GPU) 108. As shown, the processor 102 can be coupled through the bus 106 to the GPU 108. The GPU 108 can perform any number of graphics operations within the electronic device 100. For example, the GPU 108 can render or manipulate graphics images, graphics frames, videos, or the like, to be displayed to a user of the electronic device 100. In some examples, the GPU 108 includes a number of graphics engines, wherein each graphics engine is configured to perform specific graphics tasks, or to execute specific types of workloads.

The memory device 104 can include random access memory (RAM), read only memory (ROM), flash memory, or any other suitable memory systems. For example, the memory device 104 can include dynamic random access memory (DRAM). The processor 102 can be linked through the bus 106 to a display interface 110 to connect the electronic device 100 to a display device 112. The display device 112 can include a display screen that is a built-in component of the electronic device 100. The display device 112 can also include a computer monitor, television, or projector, among others, that is externally connected to the electronic device 100. In an example, the display device 112 can be a touchscreen.

The processor 102 can also be connected through the bus 106 to an input/output (I/O) device interface 114 to connect the electronic device 100 to one or more I/O devices 116. The I/O devices 116 can include, for example, a pointing device, wherein the pointing device can include a touchpad or a touchscreen, among others. The I/O devices 116 can be built-in components of the electronic device 100, or can be devices that are externally connected to the electronic device 100.

The electronic device 100 also includes a storage device 118. The storage device 118 is a physical memory such as a hard drive, solid state drive, an optical drive, a thumbdrive, a secure digital (SD) card, a microSD card, an array of drives, or any combinations thereof, among others. The storage device 118 can also include remote storage drives. The storage device 118 includes any number of applications 120 that run on the electronic device 100. The storage device 118 can also include a database 122 for storing data.

The electronic device 100 further includes a media input interface 124 to connect the electronic device 100 to one or more media input devices 126. The media input device 126 can be any suitable device for inputting media in the electronic device, such as a keyboard. For example, the media input device 126 can be a QWERTY keyboard. The media input device 126 can be a physical keyboard or a representation of a keyboard represented on a touchscreen. The media input device 126 can be an integral component of the electronic device 100 or the media input device 126 can be an external device coupled to the electronic device. The media input device 126 can be used by a user of the device to input media in the device. The media input can be visual input, audio input, textual input, or a combination thereof.

A network interface card (NIC) 128 can connect the electronic device 100 through the system bus 106 to a network (not depicted). The network (not depicted) can be a wide area network (WAN), local area network (LAN), or the Internet, among others. In an example, the electronic device 100 can connect to the network (not depicted) via a wired connection or a wireless connection.

The electronic device 100 further includes a real-time data sensor 130 to collect real-time data. The real-time data can be collected when the electronic device 100 detects that the user has initiated media input in the device. For example, the real-time data can be collected when the user initiates an application and starts typing. The real-time data can include location information (e.g., the current geographic location of the device and the network location, such as the IP address, of the electronic device), the environment around the electronic device (e.g., current environment temperature, humidity, altitude, wind speed, local events, etc.), the application in which the user is inputting text (e.g., a text editor, a chatting window, an email client, a browser address window, etc.), and the user's profile (e.g., the age, gender, profession, most recent more repeated words/sentences, recently used applications, recently visited websites, information from social networking sites, etc.), and recipient information (e.g., name, age, gender, etc. of a person to receive the text), or a combination thereof, among others. The real-time data sensor 130 can include sensors of the electronic device such as a thermometer, an accelerometer, a GPS, and a gyrometer, among others. The real-time data sensor 130 can also include a sensor to track the user's operation of the electronic device 100 and a sensor to access internet resources, among others.

The real-time data can be stored in the database 122. The data can be processed, such as by the processor 102, to determine candidates for completing the media input by the user (e.g., to predict what text the user will input next). The processor 102 will present at least one candidate for completing the media to the user. If the candidate is the media the user intended to input, the user can select the candidate and the media will automatically be entered in the device. However, if the candidate is not selected by the user, an additional candidate can be presented to the user. In an example, one candidate is presented to the user. In another example, at least five candidates are presented to the user.

When a user selects a provided candidate, the selection of the candidate can be stored in the database 122. This selection can be included in future real-time data. Additionally, failure of a user to select a given candidate or candidates can also be stored in the database 122 and included in future real-time data. As the input method continues to be employed and real-time data collected, the electronic device can learn more about the user and the quality of provided candidates will improve.

In an example, a user is located in Tokyo, Japan and opens a chatting window on his electronic device with his friend. The real-time data is collected and processed to determine appropriate candidates. As the user prepares to input data, he is provided with the following candidates: 1) Yo, what's up 2) u there? 3) Hey, I am in Tokyo right now. As the user continues chatting with his friend, he inputs “I'm going to” and is provided with the following candidates: 1) see the Japanese 31^{st} Cartoon Show 2) the Tokyo Tower 3) Take the next train to Osaka. When his friend asks “Is it still cold there?”, the user is presented with the following candidates: 1) Yeah, it's been snowing for 5 days! 2) Yeah, it is 28F now. In another example, when a user inputs textual phrase, “It's snowing,” the candidate provided can be an image of snow falling.

It is to be understood the block diagram of FIG. 1 is not intended to indicate that the electronic device 100 is to include all of the components shown in FIG. 1 in every case. Further, any number of additional components can be included within the electronic device 100, depending on the details of the specific implementation.

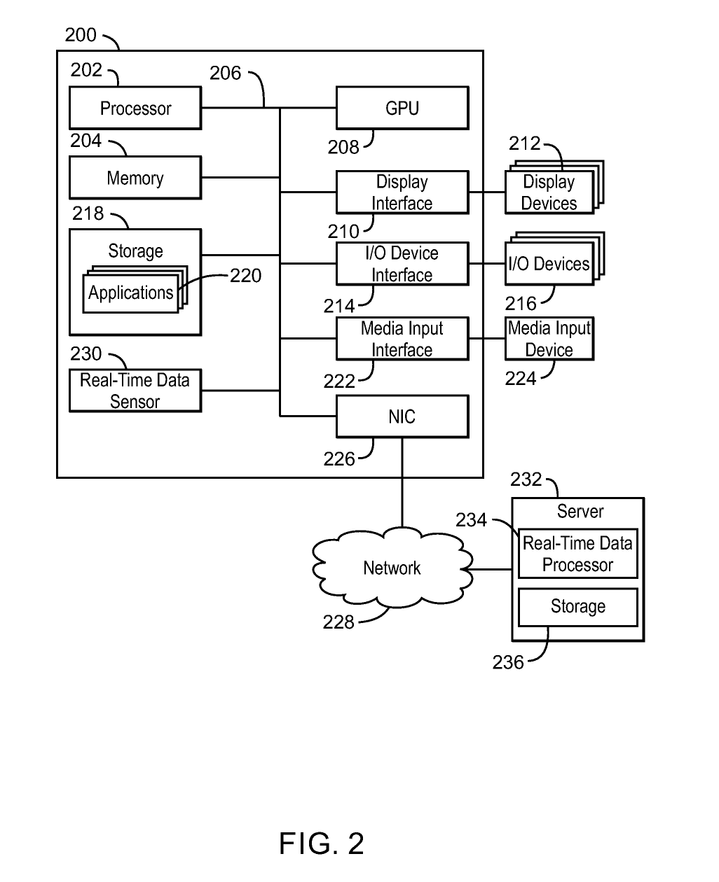

FIG. 2 is a block diagram of an example of an electronic device 200. The electronic device 200 can be a mobile device such as, for example, a laptop computer, a tablet computer, a personal digital assistant (PDA), or a cellular phone, such as a smartphone, among others. The electronic device 200 can include a processor 202 to execute stored instructions, as well as a memory device 204 that stores instructions that are executable by the processor 202. The processor 202 can be coupled to the memory device 204 by a bus 206. Additionally, the processor 202 can be a single core processor, a multi-core processor, or any number of other configurations. Furthermore, the electronic device 200 can include more than one processor 202.

The electronic device 200 can also include a graphics processing unit (GPU) 208. As shown, the processor 202 can be coupled through the bus 206 to the GPU 208. The GPU 208 can perform any number of graphics operations within the electronic device 200. For example, the GPU 208 can render or manipulate graphics images, graphics frames, videos, or the like, to be displayed to a user of the electronic device 200. In some examples, the GPU 208 includes a number of graphics engines, wherein each graphics engine is configured to perform specific graphics tasks, or to execute specific types of workloads.

The memory device 204 can include random access memory (RAM), read only memory (ROM), flash memory, or any other suitable memory systems. For example, the memory device 204 can include dynamic random access memory (DRAM). The processor 202 can be linked through the bus 206 to a display interface 210 to connect the electronic device 200 to a display device 212. The display device 212 can include a display screen that is a built-in component of the electronic device 200. The display device 212 can also include a computer monitor, television, or projector, among others, that is externally connected to the electronic device 200. In an example, the display device 212 can be a touchscreen.

The processor 202 can also be connected through the bus 206 to an input/output (I/O) device interface 214 to connect the electronic device 200 to one or more I/O devices 216. The I/O devices 216 can include, for example, a pointing device, wherein the pointing device can include a touchpad or a touchscreen, among others. The I/O devices 216 can be built-in components of the electronic device 200, or can be devices that are externally connected to the electronic device 200.

The electronic device 200 also includes a storage device 218. The storage device 218 is a physical memory such as a hard drive, an optical drive, a thumbdrive, a secure digital (SD) card, a microSD card, an array of drives, or any combinations thereof, among others. The storage device 218 can also include remote storage drives. The storage device 218 includes any number of applications 220 that run on the electronic device 200.

The electronic device 200 further includes a media input interface 222 to connect the electronic device 200 to one or more media input devices 224. The media input device 224 can be any suitable device for inputting media in the electronic device, such as a keyboard. For example, the media input device 224 can be a QWERTY keyboard. In an example, the media input device 224 can be a physical keyboard or a representation of a keyboard represented on a touchscreen. The media input device 224 can be an integral component of the electronic device 200 or the media input device 224 can be an external device coupled to the electronic device. The media input device 224 can be used by a user of the device to input media in the device.

A network interface card (NIC) 226 can connect the electronic device 200 through the system bus 206 to a network 228. The network 228 can be a wide area network (WAN), local area network (LAN), or the Internet, among others. In an example, the electronic device 200 can connect to the network 228 via a wired connection or a wireless connection.

The electronic device 200 further includes a real-time data sensor 230 to collect real-time data. The real-time data can be collected when the electronic device 200 detects that the user has initiated text input in the device. For example, the real-time data can be collected when the user initiates an application and starts entering media. The real-time data can include location information (e.g., the current geographic location of the device and the network location, such as the IP address, of the electronic device), the environment around the electronic device (e.g., current environment temperature, humidity, altitude, wind speed, local events, etc.), the application in which the user is inputting media (e.g., a text editor, a chatting window, an email client, a browser address window, etc.), and the user's profile (e.g., the age, gender, profession, most recent more repeated words/sentences, recently used applications, recently visited websites, information from social networking sites, etc.), and recipient information (e.g., name, age, gender, etc. of a person to receive the text), or a combination thereof, among others. The real-time data sensor 230 can include sensors of the electronic device such as a thermometer, an accelerometer, a GPS, and a gyrometer, among others. The real-time data sensor 230 can also include a sensor to track the user's operation of the electronic device 200 and a sensor to access internet resources, among others.

The real-time data can be transferred to a server 232 coupled to the electronic device 100 via the network 228. The real-time data can be stored in the storage 236. The data can be processed in the server, such as by the real-time data processor 234, to determine candidates for completing the media input by the user (e.g.., to predict what text the user will input next). Upon determining the candidates, the real-time data processor 234 will return the candidates to the electronic device to present at least one candidate for completing the media to the user. If the candidate is the media the user intended to input, the user can select the candidate and the media will automatically be entered in the device. However, if the candidate is not selected by the user, an additional candidate can be presented to the user. In an example, one candidate is presented to the user. In another example, at least five candidates are presented to the user.

When a user selects a provided candidate, the selection of the candidate can be stored in the storage 236. This selection can be included in future real-time data. Additionally, failure of a user to select a given candidate or candidates can also be stored in the storage 236 and included in future real-time data. Additional real-time data, such as the user's profile, can also be stored in the storage 236. As the input method continues to be employed and real-time data collected, the electronic device can learn more about the user and the quality of provided candidates will improve.

The electronic device 100 can include a traditional method of providing candidates to the user. For example, the electronic device 100 can provide candidates based on dictionaries or popular words in a network. When the electronic device 100 is coupled to the server 232, the electronic device 100 can use real-time data to provide candidates to the user. However, when the electronic device 100 is not coupled to the server 232, the electronic device can revert to the traditional method of providing candidates to the user.

It is to be understood the block diagram of FIG. 2 is not intended to indicate that the electronic device 200 is to include all of the components shown in FIG. 2 in every case. Further, any number of additional components can be included within the electronic device 200, depending on the details of the specific implementation.

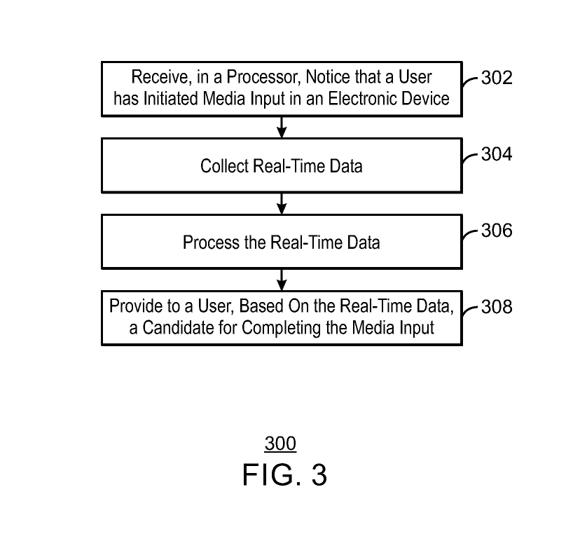

FIG. 3 is a process flow diagram of an example of a method 300 of inputting text. For example, the method 300 can be executed by the electronic device described with respect to FIG. 1. At block 302, notice that a user has initiated media input in an electronic device, such as electronic device 100, can be received in a processor, such as processor 102.

At block 304, real-time data can be collected. The real-time data can include location information, the environment around the electronic device, the application in which the user is inputting text, the user's profile, and recipient information, or a combination thereof. The real-time data can also include previous user selection of candidates. The real-time data can be collected using the electronic device's sensors, monitoring the user's operation on the device, and using internet resources, among other methods.

At block 306, the real-time data can be processed. The real-time data can be processed to determine a candidate for completing media input by a user. The candidate can be text, a number, word, a phrase, a sentence, a paragraph, a symbol, an image, or an audio clip, among others. In an example, the real-time data can be processed by a processor, such as processor 102, of the electronic device. In another example, the real-time data can be transferred to a server coupled to the electronic device for processing. The server can process the real-time data and return the candidate to the electronic device.

At block 308, the candidate, based on the real-time data, for completing the media input can be provided to the user. The candidate can be presented to the user by any suitable method. At least one candidate can be presented to the user. In another example, at least five candidates can be presented to the user. If the user does not select a candidate, an additional candidate(s) can be presented to the user. User selection of the candidate can be tracked and included in future real-time data. For example, user selection of the candidate can be stored in a database. The database can be included in an electronic device or in a server. Additional real-time data, such as the user's profile, can also be stored in the database.

It is to be understood that the process flow diagram of FIG. 3 is not intended to indicate that the elements of the method 300 are to be executed in any particular order, or that all of the elements of the method 300 are to be included in every case. Further, any number of additional elements not shown in FIG. 3 can be included within the method 300, depending on the details of the specific implementation.

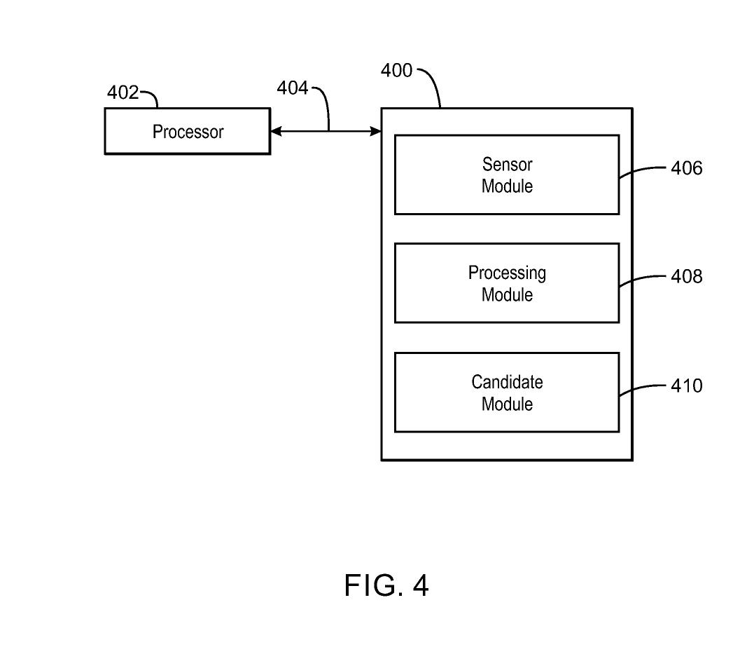

FIG. 4 is a block diagram of a tangible, non-transitory, computer-readable medium containing code for inputting media. The tangible, non-transitory, computer-readable medium is referred to by the reference number 400. The tangible, non-transitory, computer-readable medium 400 can be RAM, a hard disk drive, an array of hard disk drives, an optical drive, an array of optical drives, a non-volatile memory, a universal serial bus (USB) drive, a digital versatile disk (DVD), or a compact disk (CD), among others. The tangible, non-transitory, computer-readable storage medium 300 can be accessed by a processor 402 over a bus 404. The tangible, non-transitory, computer-readable storage medium 400 can be included in an electronic device, such as electronic device 100. Furthermore, the tangible, non-transitory, computer-readable medium 400 can include code configured to perform the methods described herein.

As shown in FIG. 4, the various components discussed herein can be stored on the non-transitory, computer readable medium 400. A first region 406 on the tangible, non-transitory, computer-readable medium 400 can include a sensor module for collecting real-time data. The real-time data can include location information (e.g., the current geographic location of the device and the network location, such as the IP address, of the electronic device). Additionally, the real-time data can include the environment around the electronic device (e.g., current environment temperature, humidity, altitude, wind speed, local events, etc.). Further, the real-time data can include the application in which the user is inputting media (e.g., a text editor, a chatting window, an email client, a browser address window, etc.), The real-time data can also include the user's profile (e.g., the age, gender, profession, most recent more repeated words/sentences, recently used applications, recently visited websites, information from social networking sites, etc.) and recipient information (e.g., name, age, gender, etc. of a person to receive the text). The sensor module can be activated to collect real-time data in response to a user beginning input of media in the electronic device. A region 408 can include a processing module to process the real-time data to determine candidates for completing the media input by a user. A region 410 can include a candidate module to present the candidates to the user for selection. Although shown as contiguous blocks, the software components can be stored in any order or configuration. For example, if the tangible, non-transitory, computer-readable medium 400 is a hard drive, the software components can be stored in non-contiguous, or even overlapping, sectors.

It is to be understood the block diagram of FIG. 4 is not intended to indicate that the tangible, non-transitory, computer-readable medium 400 is to include all of the components shown in FIG. 4 in every case. Further, any number of additional components can be included within the tangible, non-transitory, computer-readable medium 400, depending on the details of the specific implementation.

What is claimed is:

1. An electronic device for inputting media, comprising:
a media input device to receive user-initiated media input at the electronic device;
a sensor to collect real-time data during reception of the user-initiated media input, and
a processor to process the real-time data and the media input to provide a candidate based on the real-time data and the media input to be selected by a user to complete the user-initiated media input.

2. The electronic device of claim 1, wherein the input device comprising a multimedia input device, and wherein the user-initiated media input comprises visual input, audio input, textual input, or a combination thereof.

3. The electronic device of claim 1, wherein the electronic device is coupled, via a network, to a server and wherein the real-time data is transferred to the server to be processed and wherein the candidate to complete the input is returned to the device.

4. The electronic device of claim 1, wherein at least five candidates are provided to the user.

5. The electronic device of claim 1, wherein a user selection of a candidate is to be tracked and included in the real-time data.

6. The electronic device of claim 1, wherein a user's profile is to be stored in a database, the user's profile to be included in the real-time data.

7. The electronic device of claim 1, wherein the real-time data comprises location information, information about an environment around the electronic device, application information, a user's profile, recipient information, or a combination thereof.

8. The electronic device of claim 1, wherein the candidate comprises text, a number, word, a phrase, a sentence, a paragraph, a symbol, an image, an audio clip, a video clip, or a combination thereof.

9. A method for inputting media, comprising:
receiving, in a processor, notice that a user has initiated media input in an electronic device;
collecting real-time data;
processing the real-time data; and
providing to a user, based on the real-time data, a candidate for completing the media input.

10. The method of claim 9, further comprising selecting a candidate to complete the media input.

11. The method of claim 9, further comprising transferring the real-time data to a server coupled to the electronic device for processing and returning the candidate to the user.

12. The method of claim 9, wherein the real-time data comprises location information, information about an environment around the electronic device, application information, a user's profile, recipient information, or a combination thereof.

13. A tangible, non-transitory, computer-readable storage medium, comprising code to direct a processor to:
receive notice that a user has initiated media input in an electronic device;
collect real-time data;
process the real-time data; and
provide to a user, based on the real-time data, a candidate for completing the media input.

14. The tangible, non-transitory, computer-readable storage medium of claim 13, wherein the real-time data comprises current geographic location of the electronic device, network location of the electronic device, current environment around the electronic device, the application in which the user is to enter the text, the user's profile, or a combination thereof.

15. The tangible, non-transitory, computer-readable storage medium of claim 13, further comprising transferring the real-time data to a server coupled to the electronic device for processing and returning the candidate to the user.
